(19) United States
(12) Patent Application Publication
(10) Pub. No.: US 2010/0079054 A1
(43) Pub. Date: Apr. 1, 2010

(54) PROCESSING APPARATUS AND IMAGE DISPLAY DEVICE

(75) Inventors: Masato INOUE, Chigasaki-shi (JP); Shin Matsui, Fujisawa-shi (JP); Akira Kodama, Tama-shi (JP)

Correspondence Address: BUCHANAN, INGERSOLL & ROONEY PC, POST OFFICE BOX 1404, ALEXANDRIA, VA, 22313-1404, US

(73) Assignee: CANON ANELVA CORPORATION, Kawasaki-shi (JP)

(21) Appl. No.: 12/568,056

(22) Filed: Sep. 28, 2009

(30) Foreign Application Priority Data
Sep. 30, 2008 (JP) 2008-255184

(51) Int. Cl. H01J 1/62; B05C 11/00

(52) U.S. Cl. 313/483; 118/695

(57) ABSTRACT

The present invention provides a processing apparatus including a processing unit configured to process a processing object in a processing chamber by bringing a mask into contact with the processing object at a predetermined position, a base configured to hold the processing object on a holding surface, a structure configured to connect the base in a portion opposite to the holding surface of the base, and a driving unit configured to change a processing position of the processing object by pivoting the structure about a rotation shaft parallel to the holding surface of the base, the processing unit including an operation unit configured to perform, at an identical position, a fixing process and a release process, and a deposition processing unit configured to perform a deposition process on the processing object while the mask is in contact with the processing object.

### BACKGROUND OF THE INVENTION

1. Field of the Invention

The present invention relates to a processing apparatus and an image display device.

2. Description of the Related Art

One commonly-used manufacturing apparatus which manufactures an image display device is a processing apparatus which forms a desired pattern on a substrate (glass substrate) for a flat panel display, typified by an organic electroluminescent element, with a desired accuracy (i.e., which imparts a desired function to an image display device). This processing apparatus forms a pattern on a substrate using, for example, a vacuum deposition, sputtering, photolithography, or screen printing method. To keep up with the recent demand for a higher-resolution display capability of image display devices, it is necessary to form a finer pattern with high accuracy.

A vacuum deposition method is known to allow the formation of a finer pattern with low cost and high reliability, like a sputtering method, as compared with the other methods (see Japanese Patent Publication No. 6-51905). Especially in the manufacture of a display which employs an organic electroluminescent element as a display element, a vacuum deposition method is attracting attention as a dry process which almost eliminates moisture damage to an element being manufactured, that can occur in wet processes typified by a photolithography method.

A vacuum deposition method forms a pattern on a substrate as a processing object by bringing a mask having an opening corresponding to the pattern into tight contact with the surface of the substrate, and depositing a material on the substrate through the mask. In a vacuum deposition method, the precision of a pattern formed on a substrate depends on that of a mask. Under the circumstance, various kinds of techniques for forming a fine pattern (opening) on a mask with high accuracy have been proposed in the vacuum deposition method (see Japanese Patent Laid-Open No. 10-41069).

To form a fine pattern on a mask, the mask needs to have a relatively small thickness. To ensure a given pattern precision of a mask, the mask also needs to have a given tightness of contact with a substrate and a flatness good enough to prevent the mask from suffering, for example, any flexure and wrinkles.

To meet these requirements, there is proposed a technique which fixes (welds) the periphery of a metallic mask, having a thickness of 500 μm or less, on a mask frame while applying a tension to the mask (see Japanese Patent No. 3539125). Japanese Patent No. 3539125 can ensure a given mask flatness because a tension always acts on the mask. Note, however, that the mask frame needs to have high rigidity because the mask frame (its rigidity) must stand a reaction force to the tension acting on the mask. If the mask frame has low rigidity, the mask frame itself deforms by the reaction force, so the tension acting on the mask reduces. This makes it impossible to ensure a given mask flatness.

In this manner, ensuring a given pattern precision requires high rigidity of a mask frame, and this means that the weight of a metallic mask inevitably increases. Furthermore, as the size of a substrate (processing object) increases and a technique for producing a large number of devices per substrate advances in order to improve the processing capability, the size of a mask also increases. This, in turn, increases the weight of a mask. For example, there exists a metallic mask having a size of 55 inches (about 1,300 mm×800 mm) has a weight as heavy as 300 kg.

In the processing apparatus, as the mask size and weight increase, the sizes of an alignment mechanism which aligns a substrate and a mask and a transport mechanism which transports a mask naturally increase. In addition, such increases often make it difficult to handle a mask with high accuracy. The processing apparatus therefore requires a technique which allows handling of a larger, heavier mask with high accuracy.

Pattern formation by a vacuum deposition method generally requires positioning a substrate such that its pattern formation surface faces a deposition source downward (called “face-down” or “depo-up” positioning). On the other hand, a substrate and a mask are aligned by finely moving at least one of them while they are held on a base having a predetermined flatness. Therefore, to smoothly advance the process from alignment to pattern formation, it is necessary to position the aligned substrate and mask face-down free from any positional errors (grip them).

Also, a mask membranous plane (membrane) having an opening in the mask has minute flexure even when a tension is applied to this plane, so the mask has a variation in flatness as compared with the substrate (its rigidity). Due to this fact, when the mask and the substrate have low tightness of contact, and a contact surface with gaps formed between them, a deposition material enters a region other than that corresponding to the opening in the mask on the substrate. This leads to a degradation in precision of a pattern formed on the substrate (called a deposition error). At present, the tightness of contact between the mask and the substrate is reinforced as much as possible using, for example, permanent magnets and an electrostatic chuck.

Amid this struggle, there is proposed a technique which deposits a material (i.e., forms a pattern) on a substrate by dividing the substrate into a plurality of small regions, and bringing a mask into tight contact with the plurality of regions (see Japanese Patent Laid-Open No. 2003-73804). This technique can ensure a given accuracy of alignment between the mask and the substrate and reduce the weight of the mask.

FIG. 5 is a schematic perspective view showing the arrangement of a processing apparatus disclosed in Japanese Patent Laid-Open No. 2003-73804. The processing apparatus aligns, by an alignment unit 1200, a substrate held on a substrate base 1100 and a plurality of masks having identical openings (patterns). After alignment between the substrate and the plurality of masks is completed, the substrate base 1100 having the substrate and the plurality of masks fixed is turned by a substrate turning unit 1300, and is located to face a deposition source 1410 in a deposition unit 1400.

Moreover, the manufacture of, for example, a liquid crystal display and a plasma display requires various processes (surface treatments) for a substrate. For example, the manufacture of a liquid crystal display requires a process for forming a transparent electrode on the principal surface (a surface that is not an end face) of a glass substrate. A processing apparatus used in this process includes a chamber, which is to be evacuated by exhausting its internal air and into which a predetermined gas is to be introduced, in order to process a substrate in a predetermined atmosphere. A processing apparatus generally includes a plurality of chambers in order to successively perform different processes and gradually drop the pressure of the surrounding environment from the atmospheric pressure. The processing apparatuses of this kind are roughly classified into two types: the in-line type and the cluster tool type, in accordance with the layout of chambers (see Japanese Patent Laid-Open No. 2002-203885).

FIG. 6 is a schematic sectional view showing the arrangement of an in-line processing apparatus. The in-line processing apparatus includes a plurality of chambers 2100 arranged in a straight line, and a transport mechanism which transports a substrate ST upon passing through the plurality of chambers 2100. Also, gate valves 2200 are interposed between the plurality of chambers 2100. For example, the plurality of chambers 2100 include a load lock chamber 2110 opened to the external air in loading the substrate ST, an unload lock chamber 2150 opened to the external air in unloading the substrate ST, and a processing chamber 2130. Pressure control chambers 2120 and 2140 are interposed between the processing chamber 2130 and the load lock chamber 2110 and between the processing chamber 2130 and the unload lock chamber 2150, respectively. Since the load lock chamber 2110 (or the unload lock chamber 2150) and the processing chamber 2130 have a large difference in pressure, the pressure control chambers 2120 and 2140 maintain the atmosphere under their intermediate pressure.

The transport mechanism includes a tray 2310 which holds the substrate ST, and transport rollers 2320 which transport the tray 2310, as shown in FIG. 6. The transport roller 2320 is a pair of small disk-like members provided at the two ends of a rotation shaft extending in the horizontal direction perpendicular to the transport direction. The transport rollers 2320 are arranged at a predetermined interval in the transport direction. While being held on the tray 2310 (while staying in a horizontal state), the substrate ST is sequentially transported to the plurality of chambers 2100 by the transport mechanism, and processed in the plurality of chambers 2100.

FIG. 7 is a schematic plan view showing the arrangement of a cluster tool type processing apparatus. In the cluster tool type processing apparatus, load lock chambers 3200 and a plurality of processing chambers 3300 are disposed around a transport chamber 3100 which accommodates a transport robot 3110. Gate valves 3400 are interposed between the transport chamber 3100 and the load lock chambers 3200 and between the transport chamber 3100 and the processing chambers 3300. Note that the load lock chambers 3200 also have the function of an unload lock chamber in an in-line processing apparatus.

The transport robot 3110 is an articulated robot and transports a substrate while holding it at the distal end of its arm. More specifically, the transport robot 3110 transports a substrate to a predetermined position by stretchable motion, rotational motion, and vertical motion of its arm. In the cluster tool type processing apparatus, the transport robot 3110 takes out the substrate from one load lock chamber 3200 and sequentially transports it to the processing chambers 3300. Also, the transport robot 3110 takes out the processed substrate from the processing chamber 3300 and transports it to one or the other load lock chamber 3200. Note that a substrate is transported to the processing chambers 3300 in a horizontal posture and processed while maintaining a horizontal posture.

Unfortunately, as in Japanese Patent Laid-Open No. 2003-73804, when a material is deposited on a substrate by dividing the substrate into a plurality of small regions, and bringing a mask into tight contact with the plurality of regions, it takes much time to align the substrate and the mask, resulting in an increase in apparatus take time. Furthermore, from the viewpoint of producing a large number of devices per substrate, it is impossible to readily cope with an increase in size of a substrate on which a plurality of identical patterns are to be formed (deposited) at once.

An in-line processing apparatus includes a plurality of chambers in one-to-one correspondence with respective processes, and therefore can perform them in parallel. This makes it possible to shorten the substrate processing time, thus improving the processing capability. However, an in-line processing apparatus undesirably increases its redundancy on the apparatus scale and the apparatus installation area (footprint).

In contrast, a cluster tool type processing apparatus can readily cope with complication of the processes. This makes it possible to minimize the footprint. However, a cluster tool type processing apparatus requires further improvements to shorten the substrate processing time.

### SUMMARY OF THE INVENTION

The present invention provides a novel technique which can shorten the processing time of a processing object (substrate).

According to one aspect of the present invention, there is provided a processing apparatus including a processing unit configured to process a processing object in a processing chamber by bringing a mask into contact with the processing object at a predetermined position, a base configured to hold the processing object on a holding surface, a structure configured to connect the base in a portion opposite to the holding surface of the base, and a driving unit configured to change a processing position of the processing object by pivoting the structure about a rotation shaft parallel to the holding surface of the base, the processing unit including an operation unit configured to perform, at an identical position, a fixing process for fixing the processing object and the mask on the base by bringing the mask into contact with the processing object, and a release process for releasing the processing object and the mask fixed on the base, and a deposition processing unit configured to perform a deposition process on the processing object while the mask is in contact with the processing object, and the processing apparatus further including a control unit configured to control the driving unit, the operation unit, and the deposition processing unit so as to perform at least one of the fixing process and the release process and the deposition process in parallel, and so as to pivot the structure after the processes performed in parallel are completed.

According to second aspect of the present invention, there is provided an image display device including an electron source, and an image display unit which is located to face the electron source and irradiated with an electron from the electron source, the image display unit including a processing object, processed by the above processing apparatus, as a substrate.

Further features of the present invention will become apparent from the following description of exemplary embodiments with reference to the attached drawings.

### BRIEF DESCRIPTION OF THE DRAWINGS

FIG. 1 is a schematic sectional view showing the arrangement of a processing apparatus according to one aspect of the present invention.

FIGS. 2A to 2D are views for explaining the operation of the processing apparatus shown in FIG. 1.

FIG. 3 is a schematic sectional view showing another arrangement of the processing apparatus according to one aspect of the present invention.

FIGS. 4A and 4B are schematic views showing the arrangement of an image display device according to another aspect of the present invention.

FIG. 5 is a schematic perspective view showing the arrangement of a processing apparatus.

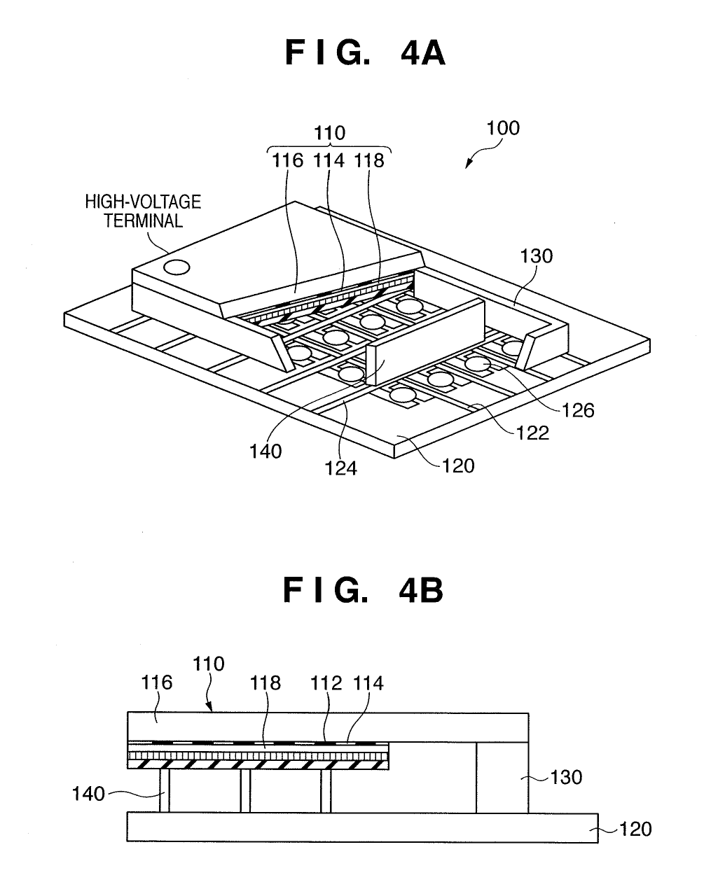

FIG. 6 is a schematic sectional view showing the arrangement of an in-line processing apparatus.

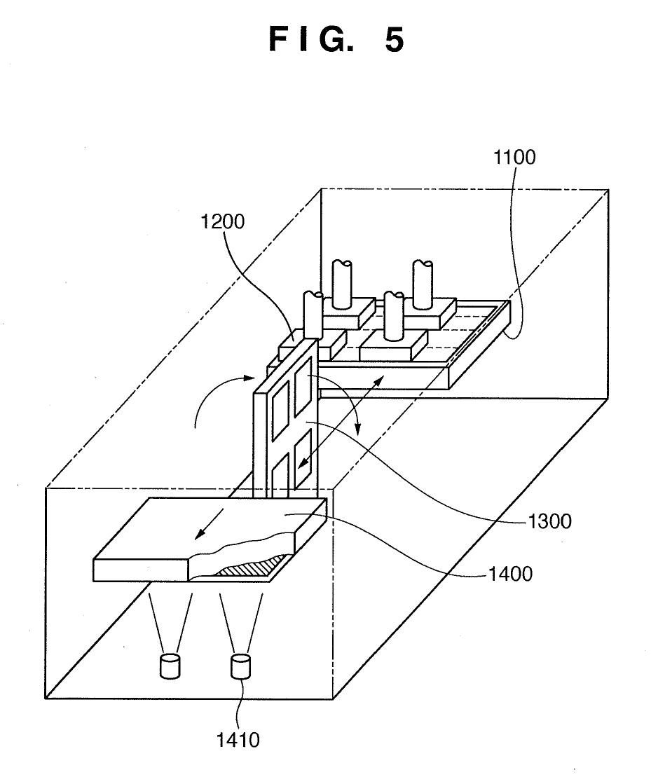

FIG. 7 is a schematic plan view showing the arrangement of a cluster tool type processing apparatus.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

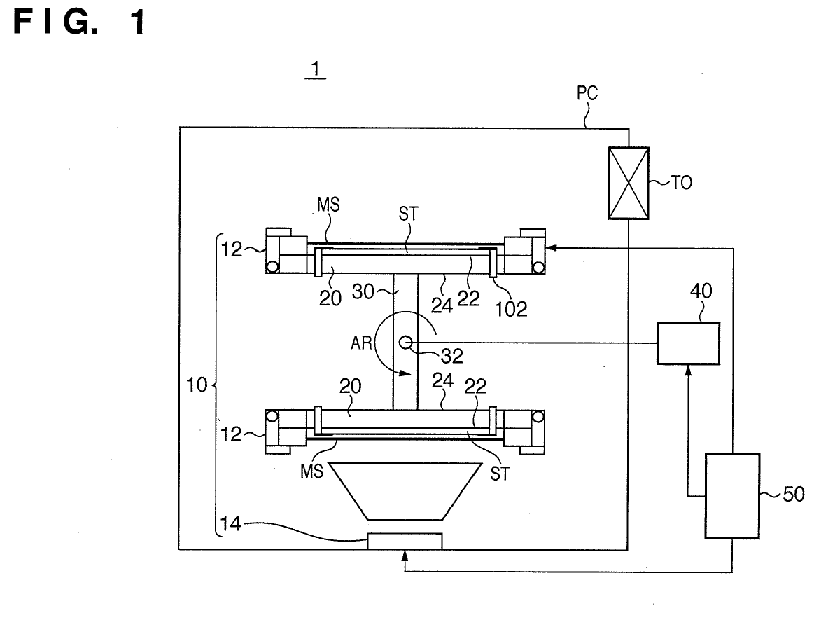

FIG. 1 is a schematic sectional view showing the arrangement of a processing apparatus 1 according to one aspect of the present invention. The processing apparatus 1 performs various processes for a processing object. In this embodiment, the processing apparatus 1 is embodied as an apparatus which forms a desired pattern on a substrate (glass substrate) for a flat panel display such as an organic electroluminescent element by performing a deposition process on the substrate.

As shown in FIG. 1, the processing apparatus 1 includes a plurality of processing units 10, a plurality of bases 20, a structure 30, a driving unit 40, and a control unit 50. The plurality of processing units 10 perform processes at a plurality of processing positions, respectively, for a substrate (processing object) ST. The plurality of bases 20 each hold the substrate ST on a holding surface 22. The structure 30 connects the plurality of bases 20 in portions opposite to the holding surfaces 22 of the plurality of bases 20. The driving unit 40 changes the processing position on the substrate ST by pivoting the structure 30 about a rotation shaft 32 parallel to the holding surfaces 22 of the plurality of bases 20. The control unit 50 controls, for example, the plurality of processing units 10 and the driving unit 40.

In FIG. 1, the processing apparatus 1 includes only one processing chamber PC to accommodate, for example, the plurality of processing units 10, the plurality of bases 20, and the structure 30, and process the substrate ST. However, the processing apparatus 1 can be a cluster tool type processing apparatus including a transport chamber to transport the substrate ST, and a plurality of processing chambers disposed around the transport chamber (see

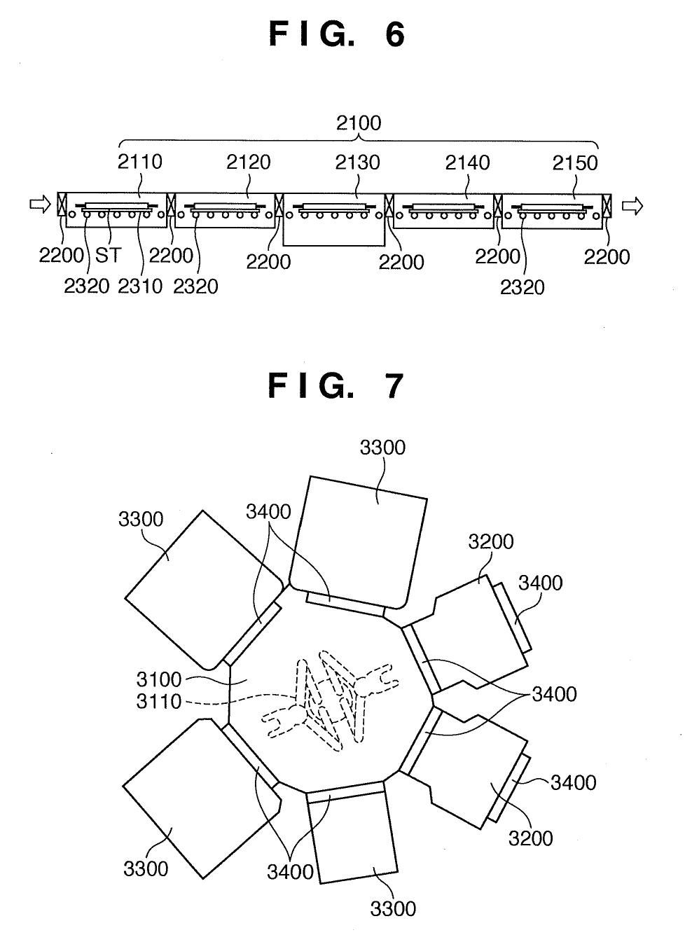

FIG. 7). In this case, at least one of the plurality of chambers accommodates, for example, the plurality of processing units 10, the plurality of bases 20, and the structure 30 (i.e., has the arrangement shown in FIG. 1). The substrate ST is loaded into and unloaded from the processing chamber PC through a transport port TO formed in the processing chamber PC.

The plurality of processing units 10 perform processes at predetermined positions, respectively, for the substrate ST in the processing chamber PC. In this embodiment, each of the plurality of processing units 10 includes an operation unit 12 and deposition processing unit 14, and performs respective processes at two processing positions.

The operation unit 12 performs a fixing process and a release process on the upper side of the rotation shaft 32. In the fixing process, a mask MS is fixed on each of the plurality of bases 20 by bringing the mask MS into tight contact with the substrate ST. In the release process, the substrate ST and mask MS fixed on each of the plurality of bases 20 are released. The operation unit 12 is, for example, rotatably mounted in the peripheral portion of the base 20, and fixes the substrate ST and the mask MS on the base 20 by mechanically fixing the mask MS (more specifically, a mask frame which fixes the mask, MS in its periphery), as shown in FIG. 1. However, the operation unit 12 may fix the substrate ST and the mask MS on the base 20 by a magnetic force. For example, if the substrate ST and the mask MS are magnetic bodies, permanent magnets, electromagnets, or the like can be used as the operation unit 12. In contrast, if the substrate ST and the mask MS are nonmagnetic bodies, an electrostatic chuck can be used as the operation unit 12.

The deposition processing unit 14 performs a deposition process on the substrate ST while the substrate ST is in tight contact with the mask MS on the lower side of the rotation shaft 32. More specifically, the deposition processing unit 14 forms a pattern by depositing a material on the substrate ST, positioned such that its pattern formation surface faces a deposition source downward (positioned face- down), through the mask MS.

The plurality of bases 20 in this embodiment include two bases 20 in correspondence with the processing units 10 (the operation unit 12 which performs a fixing process and a release process on the upper side of the rotation shaft 32, and the deposition processing unit 14 which performs a deposition process on the lower side of the rotation shaft 32) which perform processes at two processing positions.

The structure 30 in this embodiment connects two bases 20 so that the bases 20 are located at positions at which they are symmetrical about the rotation shaft 32. The structure 30 in this embodiment is made of a bar-like member which connects the bases 20 at parts of the portions 24 opposite to the holding surfaces 22 of the bases 20. However, the structure 30 is not limited to a bar-like member. For example, if the substrate ST, the mask MS, and the bases 20 are relatively heavy, the structure 30 may be made of a plate-like member which connects the bases 20 across the entire surfaces of the portions 24 opposite to the holding surface 22 of the bases 20.

The driving unit 40 includes, for example, a motor and pivots the structure 30 about the horizontal rotation shaft 32 as a center in the direction of an arrow AR in accordance with the location position of the processing units 10 (i.e., in accordance with the angles between a plurality of processing positions). The driving unit 40 in this embodiment pivots the structure 30 through 180° about the rotation shaft 32 as a center. This, in turn, pivots the bases 20 connected to the structure 30, making it possible to change the processing position of the substrate ST.

The control unit 50 include, for example, a CPU and memory and controls the operation of the processing apparatus 1. The control unit 50 in this embodiment controls the processing units 10 and the driving unit 40 so as to perform at least one of a fixing process and a release process by the operation unit 12 and a deposition process in parallel by the deposition processing unit 14, and so as to pivot the structure 30 after the processes performed in parallel are completed.

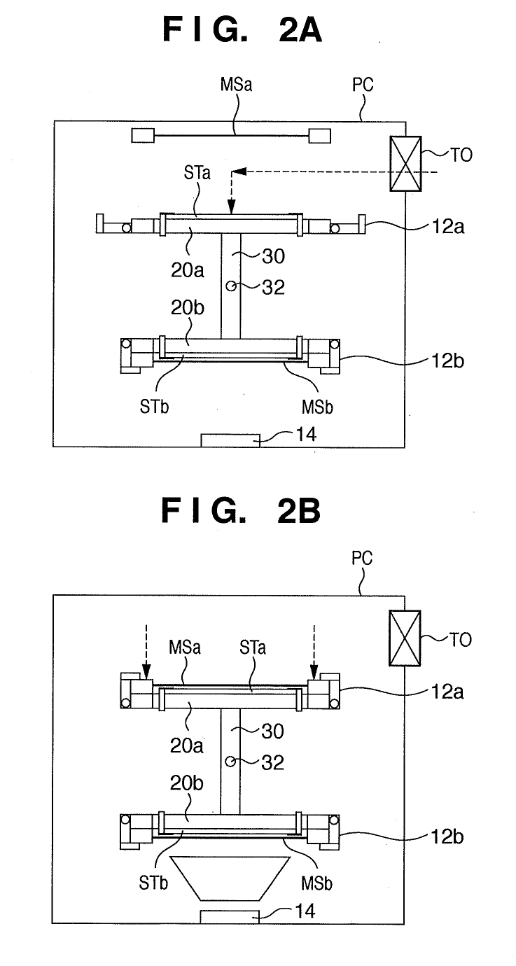

The operation of the processing apparatus 1 will be explained with reference to FIGS. 2A to 2D. Note that the operation shown in FIGS. 2A to 2D is implemented by systematically controlling each unit of the processing apparatus 1 by the control unit 50, as described above. The operation from when a substrate ST is loaded into the processing chamber PC until it is unloaded from the processing chamber PC will be explained in this embodiment.

First, as shown in FIG. 2A, a substrate STa is loaded into the processing chamber PC from its outside (e.g., a transport chamber) through the transport port TO, and held on one base 20a of the two bases 20. At this time, a mask MSa is retracted to the upper side of the base 20a by a driving mechanism (not shown). Also, a substrate STb and mask MSb, loaded into the processing chamber PC before the loading of the substrate STa, are fixed on the other base 20b of the two bases 20 while being in tight contact with each other. Note that dotted arrows in FIG. 2A indicate lines along which the substrate STa moves.

As shown in FIG. 2B, the mask MSa retracted to the upper side of the base 20a is brought into tight contact with the substrate STa, held on the base 20a, while being aligned with the substrate STa. In this state, an operation unit 12a fixes the substrate STa and the mask MSa on the base 20a. In parallel with the fixing process by the operation unit 12a, the deposition processing unit 14 deposits a material on the substrate STb, fixed on the base 20b, through the mask MSb. Note that dotted arrows in FIG. 2B indicate lines along which the mask MSa moves.

After the fixing process by the operation unit 12a and the deposition process by the deposition processing unit 14 are completed, the driving unit 40 pivots the structure 30 about the rotation shaft 32, as shown in FIG. 2C. FIG. 2C shows a state in which the structure 30 is pivoting about the rotation shaft 32. Eventually, the structure 30 pivots through 180° . With this operation, the substrate STa fixed on the base 20a moves to a processing position at which the deposition processing unit 14 can perform a deposition process. Also, the substrate STb fixed on the base 20b moves to a processing position at which the operation unit 12b can perform a release process.

As shown in FIG. 2D, the operation unit 12b releases the substrate STb and mask MSb fixed on the base 20b, and the substrate STb having a material deposited is unloaded outside the processing chamber PC through the transport port TO. At this time, the mask MSb is retracted to the upper side of the base 20b by a driving mechanism (not shown). Note that a dotted arrow in FIG. 2D indicates a line along which the substrate STb moves.

Subsequently, a new substrate is loaded into the processing chamber PC. The operation unit 12b performs a fixing process for the new substrate, and the deposition processing unit 14 performs a deposition process for the substrate STa in parallel (see FIGS. 2A and 2B). After the fixing process by the operation unit 12b and the deposition process by the deposition processing unit 14 are completed, the driving unit 40 pivots the structure 30 through 180° about the rotation shaft 32 (see FIG. 2C). The operation unit 12a releases the substrate STa and mask MSa fixed on the base 20a, and the substrate STa having a material deposited is unloaded outside the processing chamber PC though the transport port TO (see FIG. 2D). At this time, the new substrate fixed on the base 20b moves to a processing position at which the deposition processing unit 14 can perform a deposition process, as described above.

In this manner, the processing apparatus 1 according to this embodiment can perform at least one of a fixing process and a release process and a deposition process in parallel. This makes it possible to shorten the processing time of a processing object (substrate). In other words, the processing apparatus 1 according to this embodiment can process a processing object (substrate) at low cost by improving the processing capability (productivity).

The operation (the operation shown in FIGS. 2A to 2D) of the processing apparatus 1 according to this embodiment can be easily programmed and automated by systematically controlling each unit of the processing apparatus 1 by the control unit 50.

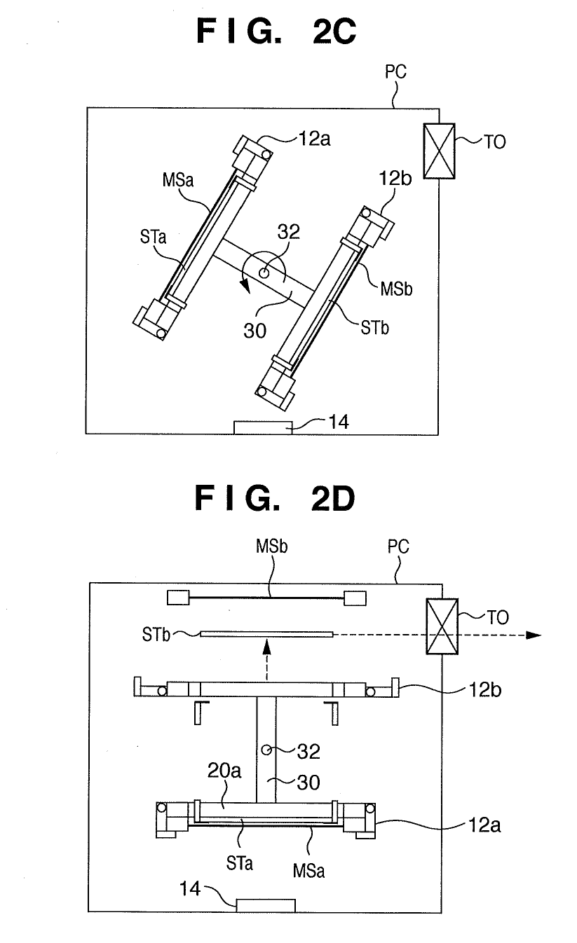

The number of processing positions in the processing apparatus 1 is not limited to two, and can also be, for example, four, as shown in FIG. 3. The processing apparatus 1 shown in FIG. 3 can perform a deposition process by the deposition processing unit 14 even on the lateral sides of the rotation shaft 32 (i.e., at three processing positions). In this case, the structure 30 connects four bases 20 so that the four bases 20 are located equiangularly)(90° about the rotation shaft 32. The driving unit 40 pivots the structure 30 every 90° about the rotation shaft 32 as a center. The processing apparatus 1 shown in FIG. 3 can further shorten the processing time of a processing object (substrate) as compared with that shown in FIG. 1. The processing apparatus 1 shown in FIG. 1 performs a fixing process and a release process at the same position, whereas that shown in FIG. 3 can also perform a fixing process and a release process at different positions. More specifically, it is only necessary to perform a deposition process at two processing positions, and perform a fixing process and a release process at the two remaining processing positions. Note that FIG. 3 is a schematic sectional view showing another arrangement of the processing apparatus 1 according to one aspect of the present invention.

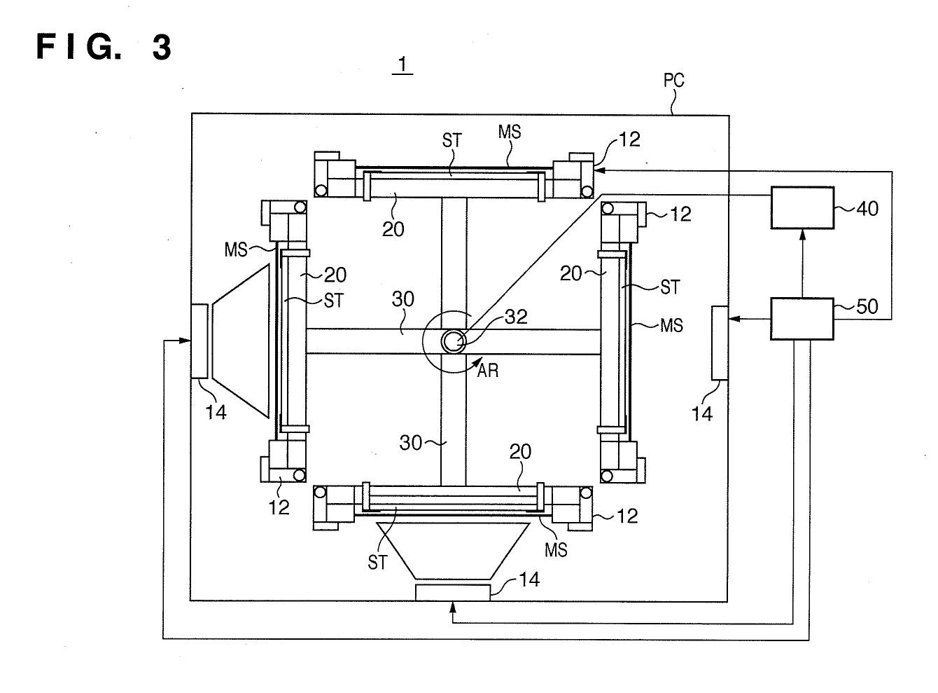

An image display device according to another aspect of the present invention will be explained below. FIGS. 4A and 4B are schematic views showing the arrangement of an image display device 100 according to another aspect of the present invention. FIG. 4A is a partially cutaway perspective view showing the image display device 100, and FIG. 4B is a partial sectional view showing the image display device 100.

The image display device 100 includes an electron source, and an image display unit which is located to face the electron source and irradiated with electrons from the electron source. More specifically, the image display device 100 includes a face plate 110, rear plate 120, side wall 130, and spacer 140. The face plate 110, rear plate 120, side wall 130, and spacer 140 constitute an airtight container.

A glass substrate 116 having a black stripe 112 and phosphor body 114 formed is located on the side of the lower surface of the face plate 110 (a surface facing the rear plate 120) as an image display unit. A metal back (acceleration electrode) 118 as a conductive member is formed on the surface of the phosphor body 114.

A row-direction interconnection 122, column-direction interconnection 124, and electron- emitting elements 126 are formed on the glass substrate 116 on the rear plate 120. The metal back 118 has a function of accelerating and drawing up electrons emitted by the electron-emitting elements 126 formed on the rear plate 120. The metal back 118 is applied with a high voltage from a high-voltage terminal, and has a specified potential higher than that of the row- direction interconnection 122.

The processing apparatus 1 mentioned above forms a pattern on the glass substrate 116 by depositing a predetermined metal material. The glass substrate 116 used in the image display device 100 is required to be inexpensive. Forming a metal pattern by the processing apparatus 1 makes it possible to manufacture the image display device 100 at low cost. Conceivable examples of the metal pattern formed by the processing apparatus 1 are a metal interconnection and a metal getter (a getter pump inserted in a vacuum sealing structure such as a cathode-ray tube).

The processing apparatus according to this embodiment is not limited to processing of a substrate used in an image display device, and is also applicable to processing of substrates for, for example, a semiconductor integrated circuit element and an organic electroluminescent element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-255184 filed on September 30, 2008, which is hereby incorporated by reference herein in its entirety.

What is claimed is:

1. A processing apparatus comprising:
a processing unit configured to process a processing object in a processing chamber by bringing a mask into contact with the processing object at a predetermined position;
a base configured to hold the processing object on a holding surface;
a structure configured to connect said base in a portion opposite to the holding surface of said base; and
a driving unit configured to change a processing position of the processing object by pivoting said structure about a rotation shaft parallel to the holding surface of said base, said processing unit including an operation unit configured to perform, at an identical position, a fixing process for fixing the processing object and the mask on said base by bringing the mask into contact with the processing object, and a release process for releasing the processing object and the mask fixed on said base, and a deposition processing unit configured to perform a deposition process on the processing object while the mask is in contact with the processing object, and the processing apparatus further comprising a control unit configured to control said driving unit, said operation unit, and said deposition processing unit so as to perform at least one of the fixing process and the release process and the deposition process in parallel, and so as to pivot said structure after the processes performed in parallel are completed.

2. The apparatus according to claim 1, wherein the processing apparatus includes a cluster tool type processing apparatus comprising a transport chamber configured to transport the processing object, and a plurality of chambers disposed around said transport chamber, and said base and said structure are accommodated in at least one of said plurality of chambers.

3. The apparatus according to claim 1, wherein said operation unit fixes the processing object and the mask on said base by a magnetic force.

4. An image display device comprising an electron source, and an image display unit which is located to face the electron source and irradiated with an electron from the electron source, the image display unit including a processing object, processed by a processing apparatus defined in claim 1, as a substrate.
